(19) United States
(12) Patent Application Publication
(10) Pub. No.: US 2012/0050707 A1
(43) Pub. Date: Mar. 1, 2012

(54) Source-collector module with GIC mirror and tin wire EUV LPP target system

(75) Inventors: Richard A. Levesque, Livermore, CA (US); Natale M. Ceglio, Pleasanton, CA (US); Giovanni Nocerino, Pleasanton, CA (US); Fabio Zocchi, Samarate (IT)

(73) Assignee: MEDIA LARIO S.R.L

(21) Appl. No.: 12/807,170

(22) Filed: Aug. 30, 2010

(51) Int. Cl. G03B 27/52; H05G 2/00

(52) U.S. Cl. 355/55; 250/504 R

(57) ABSTRACT

A source-collector module (SOCOMO) for generating a laser-produced plasma (LPP) that emits EUV radiation, and a grazing-incidence collector (GIC) mirror arranged relative to the LPP and having an input end and an output end. The LPP is formed using an LPP target system having a light source portion and a target portion, wherein a pulsed laser beam from the light source portion irradiates a Sn wire provided by the target portion. The GIC mirror is arranged relative to the LPP to receive the EUV radiation at its input end and focus the received EUV radiation at an intermediate focus adjacent the output end. A radiation collection enhancement device having at least one funnel element may be used to increase the amount of EUV radiation provided to the intermediate focus and/or directed to a downstream illuminator. An EUV lithography system that utilizes the SOCOMO is also disclosed.

### FIELD

The present disclosure relates generally to grazing-incidence collectors (GICs), and in particular to a source-collector module for use in an extreme ultraviolet (EUV) lithography system that employs a laser-produced plasma (LPP) target system that uses tin wire to generate EUV radiation.

### BACKGROUND ART

Laser-produced plasmas (LPPs) are formed in one example by irradiating Sn droplets with a focused laser beam. Because such LPPs can radiate in the extreme ultraviolet (EUV) range of the electromagnetic spectrum, they are considered to be a promising EUV radiation source for EUV lithography systems.

FIG. 1 is a schematic diagram of a generalized configuration for a prior art LPP-based source-collector module (“LPP-NIC SOCOMO”) 10 that uses a normal-incidence collector (“NIC”) mirror MN, while FIG. 2 is a more specific example configuration of the “LPP-NIC” SOCOMO 10 of FIG. 1. The LPP-NIC SOCOMO 10 includes a high-power laser 12 that generates a high-power, high-repetition-rate laser beam 13 having a focus F13. LPP-NIC SOCOMO 10 also includes along an axis A1 a fold mirror FM and a large (e.g., ˜600 mm diameter) ellipsoidal NIC mirror MN that includes a surface 16 with a multilayer coating 18. The multilayer coating 18 is essential to guarantee good reflectivity at EUV wavelengths. LPP-NIC SOCOMO 10 also includes a Sn source 20 that emits a stream of tin (Sn) pellets 22 that pass through laser beam focus F13.

In the operation of LPP-NIC SOCOMO 10, laser beam 13 irradiates Sn pellets 22 as the pellets pass through the laser beam focus F13, thereby produce a high-power LPP 24. LPP 24 typically resides on the order of hundreds of millimeters from NIC mirror MN and emits EUV radiation 30 as well as energetic Sn ions, particles, neutral atoms, and infrared (IR) radiation. The portion of the EUV radiation 30 directed toward NIC mirror MN is collected by the NIC mirror MN and is directed (focused) to an intermediate focus IF to form a focal spot FS. The intermediate focus IF is arranged at or proximate to an aperture stop AS. Only that portion of the EUV radiation 30 that makes it through aperture stop AS forms focal spot FS. Here it is noted that focal spot FS is not an infinitely small spot located exactly at intermediate focus IF, but rather is a distribution of EUV radiation 30 generally centered at the intermediate focus IF.

Advantages of LPP-NIC SOCOMO 10 are that the optical design is simple (i.e., it uses a single ellipsoidal NIC mirror) and the nominal collection efficiency can be high because NIC mirror MN can be designed to collect a large angular fraction of the EUV radiation 30 emitted from LPP 24. It is noteworthy that the use of the single-bounce reflective NIC mirror MN placed on the opposite side of LPP 24 from the intermediate focus IF, while geometrically convenient, requires that the Sn source 20 not significantly obstruct EUV radiation 30 being delivered from the NIC mirror MN to the intermediate focus IF. Thus, there is generally no obscuration in the LPP-NIC SOCOMO 10 except perhaps for the hardware needed to generate the stream of Sn pellet 22.

LPP-NIC SOCOMO 10 works well in laboratory and experimental arrangements where the lifetime and replacement cost of LPP-NIC SOCOMO 10 are not major considerations. However, a commercially viable EUV lithography system requires a SOCOMO that has a long lifetime. Unfortunately, the proximity of the surface 16 of NIC mirror MN and the multilayer coatings 18 thereon to LPP 24, combined with the substantially normally incident nature of the radiation collection process, makes it highly unlikely that the multilayer coating 18 will remain undamaged for any reasonable length of time under typical EUV-based semiconductor manufacturing conditions.

A further drawback of the LPP-NIC SOCOMO 10 is that it cannot be used in conjunction with a debris mitigation tool based on a plurality of radial lamellas through which a gas is flowed to effectively stop ions and neutrals atoms emitted from the LPP 24 from reaching NIC mirror MN. This is because the radial lamellas would also stop the EUV radiation 30 from being reflected from NIC mirror MN.

Multilayer coating 18 is also likely to have its performance significantly reduced by the build-up of Sn, which significantly absorbs the incident and reflected EUV radiation 30 thereby reducing the reflective efficiency of the multilayer coated ellipsoidal mirror. Also, the aforementioned energetic ions, atoms and particles produced by LPP 24 will bombard multilayer coating 18 and destroy the layered order of the top layers of the multilayer coating 18. In addition, the energetic ions, atoms and particles will erode multilayer coating 18, and the attendant thermal heating from the generated IR radiation can act to mix or interdiffuse the separate layers of the multilayer coating 18.

While a variety of fixes have been proposed to mitigate the above-identified problems with LPP-NIC SOCOMO 10, they all add substantial cost and complexity to the LPP-NIC SOCOMO 10, to the point where it becomes increasingly unrealistic to include it in a commercially viable EUV lithography system. Moreover, the Sn droplet LPP EUV light source is a complex and expensive part of the LPP-NIC SOCOMO 10. What is needed therefore is a less expensive, less complex, more robust and generally more commercially viable SOCOMO for use in an EUV lithography system that uses a simpler and more cost-effective LPP-based EUV radiation source.

### SUMMARY

The present disclosure is generally directed to grazing incidence collectors (GICs), and in particular to GIC mirrors used to form a source-collector module (SOCOMO) for use in EUV lithography systems, where the SOCOMO includes a LPP target system that uses tin wire and a laser to generate EUV radiation.

An aspect of the disclosure is a SOCOMO for an EUV lithography system. The SOCOMO includes a laser that generates a pulsed laser beam, and a fold mirror arranged along a SOCOMO axis and configured to receive the pulsed laser beam and reflect the pulsed laser beam down the SOCOMO axis in a first direction. The SOCOMO also includes a Sn wire source configured to move a Sn wire over a wire guide path that includes an irradiation location where the Sn wire is irradiated by the pulsed laser beam, thereby creating a LPP that generates EUV radiation in a second direction that is generally opposite the first direction. The SOCOMO also includes a GIC mirror having an input end and an output end and arranged to receive the EUV radiation at the input end and focus the received EUV radiation at an intermediate focus adjacent the output end.

Another aspect of the disclosure is a method of collecting EUV radiation from a LPP. The method includes providing a GIC mirror along an axis, the GIC mirror having input and output ends. The method also includes arranging adjacent the input end of GIC mirror an LPP target system configured to provide Sn wire having a diameter, including moving the Sn wire past an irradiation location. The method further includes sending a pulsed laser beam down the axis of GIC mirror axis and through the GIC mirror from the output end to the input end and focused onto to the Sn wire at the irradiation location, thereby forming the LPP that emits the EUV radiation. The method also includes collecting with the GIC mirror at the input end of GIC mirror a portion of the EUV radiation from the LPP and directing the collected EUV radiation out of the output end of GIC mirror to form a focal spot at an intermediate focus.

Another aspect of the disclosure is a LPP target system. The LPP target system includes a laser that generates a pulsed laser beam, a Sn wire storage reel that stores a length of Sn wire, and a Sn wire take-up reel that stores a length of irradiated Sn wire. The LPP target system also includes at least one guide wire unit that guides the Sn wire over a wire guide path from the storage reel to the take-up reel. The wire guide path includes an irradiation location between the storage-reel and the take-up reel where the Sn wire is irradiated by the pulsed laser beam.

Additional features and advantages of the disclosure are set forth in the detailed description below, and in part will be readily apparent to those skilled in the art from that description or recognized by practicing the disclosure as described herein, including the detailed description which follows, the claims, as well as the appended drawings.

### BRIEF DESCRIPTION OF THE DRAWINGS

FIG. 1 is a schematic diagram of a generalized example prior art LPP-NIC SOCOMO;

FIG. 2 is a schematic diagram of a particular example of a prior art LPP-NIC SOCOMO in accordance with FIG. 1;

FIG. 3A is a generalized schematic diagram of an example GIC-based SOCOMO for an LPP source (“LPP-GIC SOCOMO”), wherein the LPP and intermediate focus are on opposite sides of the GIC mirror;

FIG. 3B is similar to FIG. 3A, wherein the LPP-GIC SOCOMO additionally includes an optional radiation collection enhancement device (RCED) arranged between the GIC mirror and the intermediate focus, with the example RCED having upstream and downstream funnel elements on respective sides of the intermediate focus;

FIG. 4 is a schematic diagram of example LPP-GIC SOCOMO based on the generalized configuration of FIG. 3B, and showing the light source portion and the target portion of the LPP target system;

FIG. 5 is a schematic side view of an example target portion of the target system of FIG. 4 that includes a Sn wire source for generating EUV radiation;

FIG. 6 is a cross-sectional diagram of an example GIC mirror having two sections with respective first and second surfaces that provide first and second reflections of EUV radiation;

FIG. 7 is a schematic cross-sectional diagram of a portion of an example GIC mirror showing two of the two-section GIC mirror shells used in the outer portion of the GIC mirror;

FIG. 8 is a schematic cross-sectional diagram of a portion of the GIC mirror of FIG. 7 showing by way of example eight GIC mirror shells and the LPP;

FIG. 9A is a plot of the normalized far-field position vs. Intensity (arbitrary units) for the case where the GIC mirror shells do not include a polynomial surface-figure correction to improve the far-field image uniformity;

FIG. 9B is the same plot as FIG. 9A but with a polynomial surface-figure correction that improves the far-field image uniformity; and

FIG. 10 is a schematic diagram of an EUV lithography system that utilizes the LPP-GIC SOCOMO of the present disclosure.

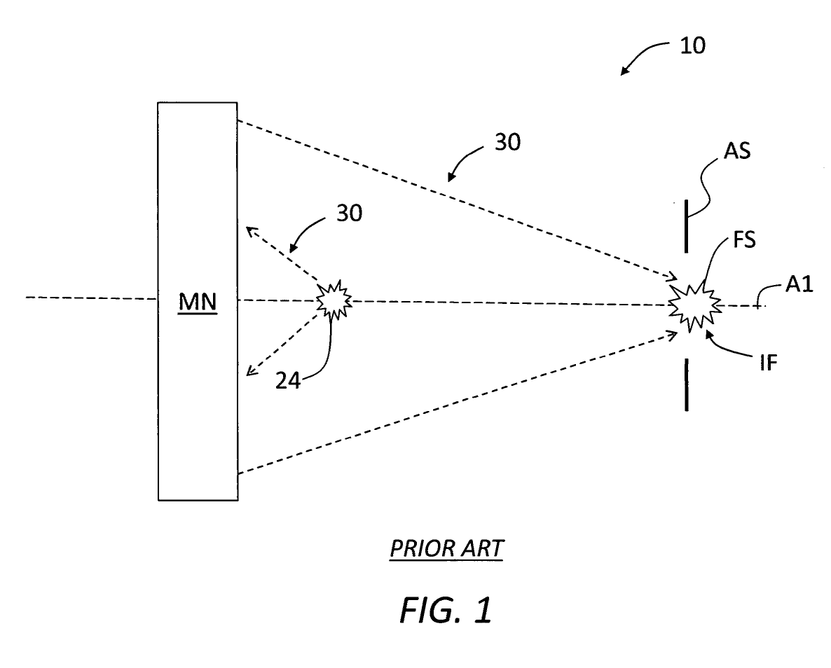

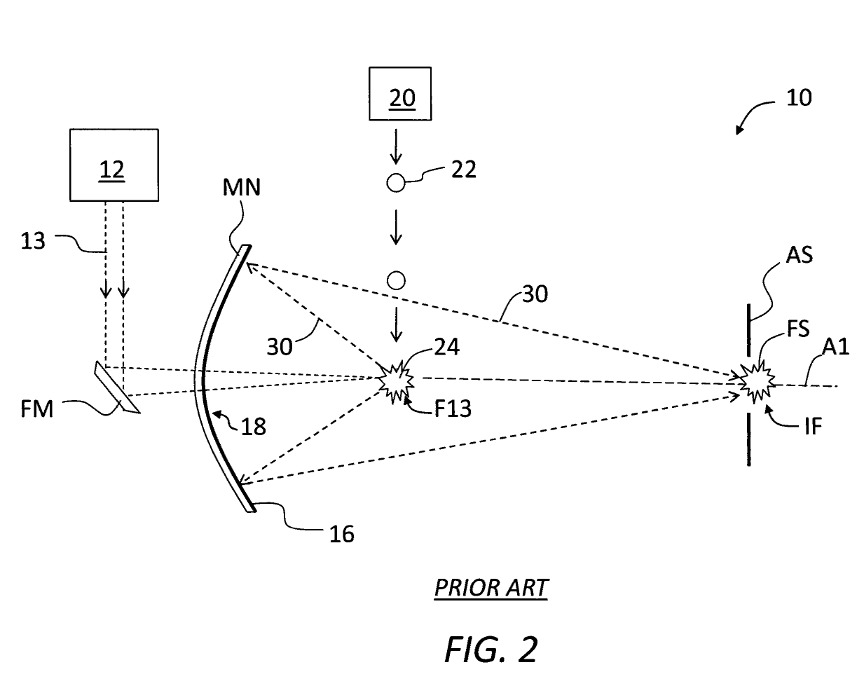

The various elements depicted in the drawing are merely representational and are not necessarily drawn to scale. Certain sections thereof may be exaggerated, while others may be minimized. The drawing is intended to illustrate an example embodiment of the disclosure that can be understood and appropriately carried out by those of ordinary skill in the art.

### DETAILED DESCRIPTION

The present disclosure is generally directed to GICs, and in particular to GIC mirrors used to form a source-collector module (SOCOMO) for use in EUV lithography systems that have a LPP-based EUV light source.

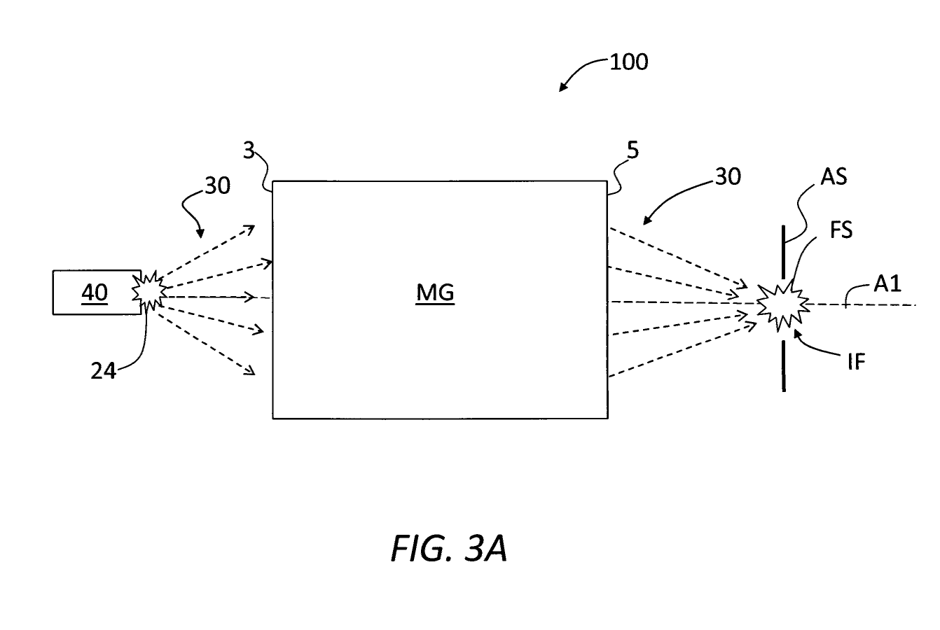

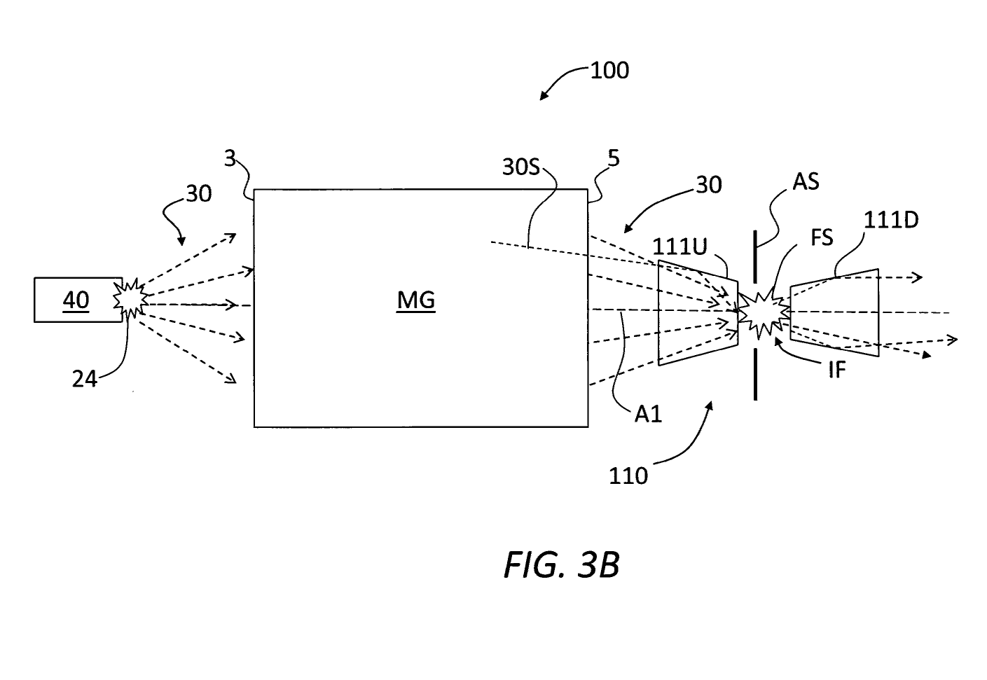

FIG. 3A and FIG. 3B are generalized schematic diagrams of example LPP-GIC SOCOMOs 100, wherein LPP 24 and intermediate focus IF are on opposite sides of a GIC mirror MG. GIC mirror MG has an input end 3 and an output end 5. An LPP target system 40 that generates LPP 24 is also shown, and an example of the LPP target system 40 is discussed in detail below. In FIG. 3B, LPP-GIC SOCOMO 100 further includes an optional radiation collection enhancement device (RCED) 110, such as described in U.S. Provisional Patent Application Ser. No. 61/341,806 entitled “EUV collector system with enhanced EUV radiation collection,” which application is incorporated by reference herein. RCED 110 is arranged along optical axis A1 immediately adjacent intermediate focus IF and aperture stop AS on the side of GIC mirror MG and is configured to increase the amount of EUV radiation 30 that makes it through the aperture stop AS to the intermediate focus IF to form focal spot FS. This is illustrated by a skew EUV ray 30S that is redirected by RCED 110 through aperture stop AS to form focal spot FS.

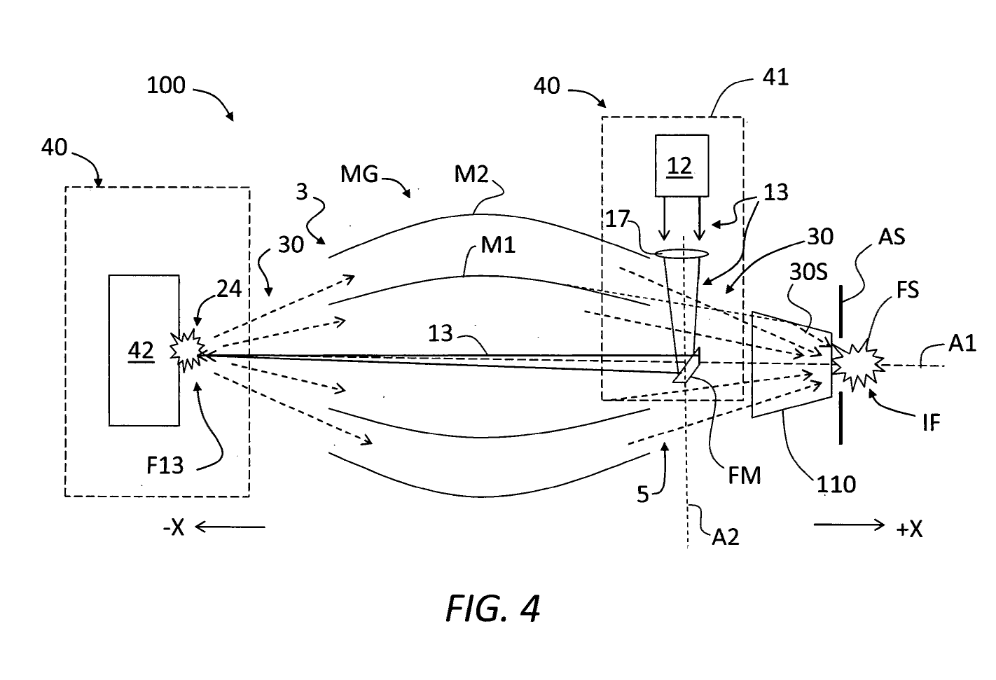

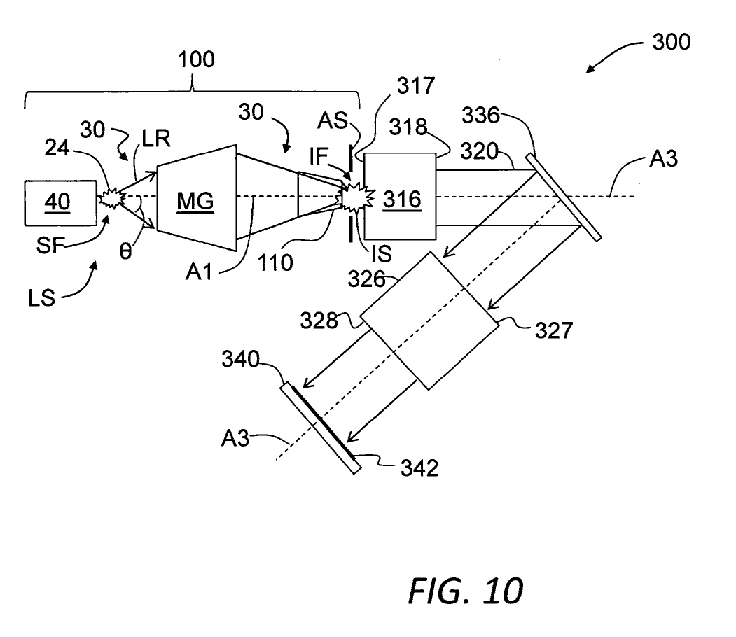

In an example embodiment, RCED 110 includes an inverted funnel-like element (downstream funnel element) 111D arranged downstream of intermediate focus IF and configured to direct EUV radiation 30 from intermediate focus IF to a downstream position, such as to the illumination optics (see FIG. 10, introduced and discussed below). Such an embodiment can be effective in making the projected EUV radiation 30 at a downstream illuminator more uniform and thereby better utilized at the reticle plane. RCED 110 may include upstream and downstream funnel elements 111U and 111D, where upstream and downstream here are defined relative to intermediate image IF. RCED 110 may include just the upstream funnel element 111U (see e.g., FIG. 4) or just the downstream funnel element 111D. In another example, RCED 110 is a continuous (monolithic) element that combines the upstream and downstream funnel elements 111U and 111D to form a single funnel element 111 that has upstream and downstream funnel portions rather than separate elements. In the case where a single funnel element 111 is used, it is simply referred to as RCED 110.

FIG. 4 is a schematic diagram of an example LPP-GIC SOCOMO 100 based on the general configuration of FIG. 3B. LPP-GIC SOCOMO 100 of FIG. 4 utilizes an LPP target system 40 that includes a light source portion 41 and a target portion 42. Light source portion 41 includes a laser 12 that generates a laser beam 13 along an axis A2 that is perpendicular to optical axis A1. Light source portion 41 also includes a fold mirror FM arranged along optical axis A1 at the intersection of axes A1 and A2, which intersection lies between GIC mirror MG and intermediate focus IF (e.g., between the GIC mirror MG and RCED 110). This allows for a configuration where a multi-shell GIC mirror MG (shown in FIG. 4 has having two GIC mirror shells M1 and M2 by way of example) is arranged along optical axis A1 between LPP 24 and intermediate focus IF. A lens 17 adjacent laser 12 assists in focusing laser beam 13 to a focus F13 at target portion 42 to form LPP 24, as discussed in greater detail below. In an example embodiment, GIC mirror shells M1 and M2 include Ru coatings (not shown) on their respective reflective surfaces.

Target portion 42 is irradiated by laser beam 13 traveling through GIC mirror MG in the −X direction along optical axis A1, thereby creating EUV radiation 30 that is emitted generally in the +X direction. The axial obscuration presented by fold mirror FM is minimal. Thus, laser beam 13 travels in one direction (i.e., the −X direction) through GIC mirror MG generally along optical axis A1 and EUV radiation 30 travels generally in the opposite direction (i.e., the +X direction) through the GIC mirror MG, RCED 110 and to intermediate focus IF.

### LPP Target System

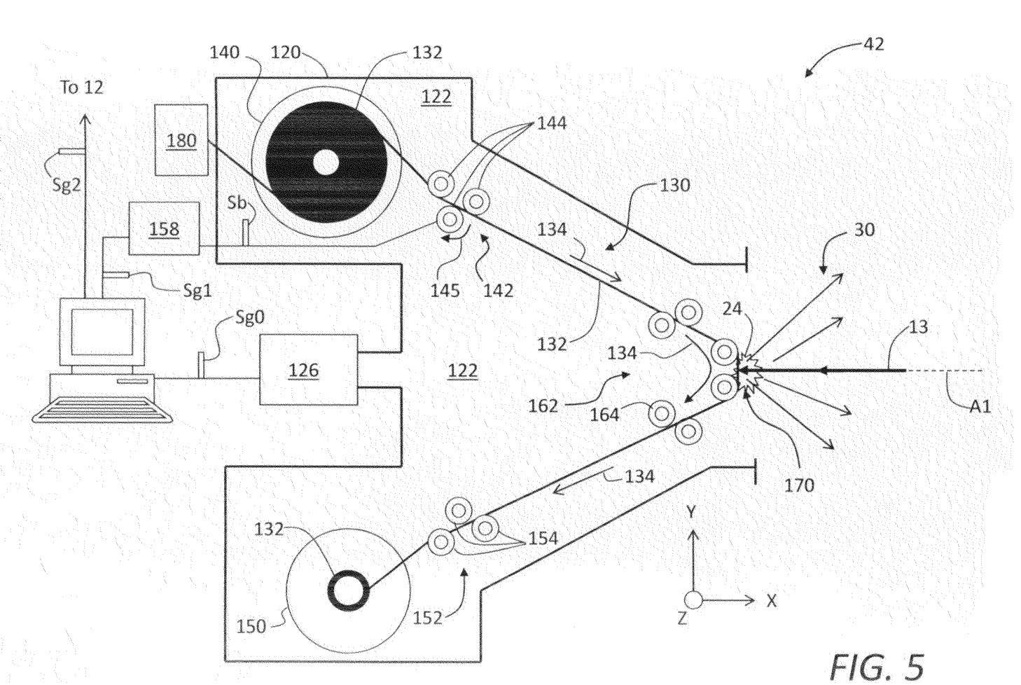

FIG. 5 is a schematic side view of an example target portion 42 that constitutes a Sn wire source used to generate EUV radiation 30. Cartesian X-Y-Z coordinates are shown for the sake of reference. Target portion 42 includes a vacuum chamber 120 having a chamber interior 122. A vacuum system 126 is pneumatically coupled to chamber interior 122 and is operable to pull a vacuum therein. Target portion 42 includes a wire reel system 130 within chamber interior 122 configured to provide a metered dispensing of Sn wire 132. In an example embodiment, Sn wire 132 is formed by coating a non-Sn structure with a Sn coating, which coating in one embodiment has a thickness of about 0.5 microns or greater. Wire reel system 130 includes a wire supply reel 140 that stores an amount of Sn wire 132, and a take-up reel 150 that receives and stores an amount of processed Sn wire 132. The Sn wire 132 moves over a wire guide path 134.

Associated with wire supply reel 140 is a first wire guide unit 142 that includes for example of rollers 144 configured to guide Sn wire 132. Likewise, associated with wire take-up reel 150 is a second wire guide unit 152 that includes for example a number of rollers 154 configured not only to guide Sn wire 132, but to also drive the Sn wire 132 and provide the proper wire tension. A drive unit 158 is operably connected to one of the rollers 144 to form a drive roller, as indicated by arrow 145.

Both wire supply reel 140 and wire take-up reel 150 are movable to account for the dispensing of Sn wire 132 and the collection of the Sn wire 132 to maintain the movement of the Sn wire 132 over the wire guide path 134, the needed wire tension, the wire speed, and other wire reel system operating parameters.

Target portion 42 also includes a third wire guide unit 162 that includes for example a number of rollers 164 configured to guide Sn wire 132 and provide an irradiation location 170 on optical axis A1 where laser beam 13 irradiates the Sn wire 132 to form EUV radiation 30. Wire guide units 142, 152 and 162 serve to define the wire guide path 134 through wire reel system 130.

Target portion 42 includes a controller 200 that is operably connected to vacuum system 126, drive unit 158 and laser 12 of light source portion 41 of LPP target system 40 (see FIG. 4). An example controller 200 includes a computer that can store instructions (software) in a computer readable medium (memory) to cause the computer (via a processor therein) to carry out the instructions to operate LPP target system 40 to generate LPP 24.

With continuing reference to FIG. 5, in the operation of target portion 42, controller 200 sends a signal Sg0 to vacuum system 126, which causes the vacuum system 126 to pull a vacuum in interior 122 of vacuum chamber 120. Here it is assumed that vacuum chamber 120 is connected to or is part of a larger vacuum chamber (not shown) that houses LPP-GIC SOCOMO 100. Controller 200 also sends a signal Sg1 to drive unit 158, which in response thereto drives a roller 144, thereby causes Sn wire 132 to be unspooled from wire supply reel 140 and guided over the wire guide path 134, including through irradiation location 170 and then to take-up reel 150. Information about the speed of drive roller is feed back to controller 200 via a feedback signal Sb so that the Sn wire speed can be precisely controlled.

Controller 200 also sends signals Sg2 to laser 12 in light source portion 41 (FIG. 4) to initiate the formation of laser beam 13. In an example, the laser focal spot FS of laser beam 13 is preferably smaller than the diameter of the Sn wire 132 so such that laser beam 13 irradiates a portion of the moving Sn wire 132 that passes through irradiation location 170, forming LPP 24, which emits EUV radiation 30 generally in the +X direction.

The continual movement of Sn wire 132 through irradiation location 170 provides for continuous source Sn and allows for high repetition rates and long run times for LPP 24. In an example embodiment, Sn wire 132 is moved at a speed such that each laser pulse in laser beam 13 is incident upon a fresh Sn surface. In an example embodiment, the direction of Sn wire travel is reversed and the wire guide path 134 shifted in the Z-direction to that a fresh portion of Sn wire 132 is irradiated by laser beam 13. This embodiment is particularly useful when Sn wire 132 has a width in the Z-direction that allows for multiple Z-positions of the Sn wire 132 to be irradiated without irradiating the same spot twice. In an example where laser beam 13 forms a 25 micron spot size and a laser 12 has a pulse rate of 1 KHz, the wire speed is about 1 inch per second or about 300 feet per hour.

Not all of Sn wire 132 at irradiation location 170 is consumed in forming LPP 24, however, which allows the “processed” Sn wire 132 to continue along the wire guide path 134 to take-up reel 150. Thus, Sn wire 132 is configured such that irradiation by laser beam 13 does not break the Sn wire 132, which would prevent taking up the process Sn wire 132 and otherwise maintaining tension and wire speed.

Sn wire 132 can have a variety of forms beyond conventional wire, such as tape, chain, foil tape, beaded chain, ribbon, rope, cable, thread, conventional wire, line, etc., and that the term “wire” as understood herein is to be generally construed to include a continuous or contiguous flexible Sn (or Sn-coated) structure that can be stored on a storage reel, guided over a guide path that includes irradiation location 170, and then stored on a take-up reel 150.

In another example embodiment, a Sn wire source 180 is operably coupled to wire supply reel 140 to provide a continuous supply of Sn wire 132 so that the overall operation of LPP target system 40 can continue without running out of Sn wire 132. An example Sn wire source 180 is, for example, another wire supply reel 140.

SOCOMO with No First-Mirror Multilayer

An example configuration of LPP-GIC SOCOMO 100 has no multilayer-coated “first mirror,” i.e., the mirror or mirror section upon which EUV radiation 30 is first incident (i.e., first reflected) does not have a multilayer coating 18. In another example configuration of LPP-GIC SOCOMO 100, the first mirror is substantially a grazing incidence mirror. In other embodiments, the first mirror may include a multilayer coating 18.

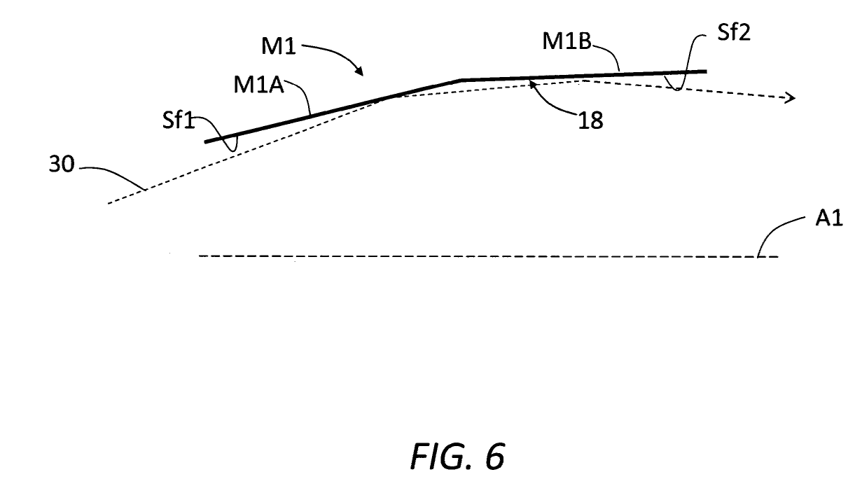

A major advantage of LPP-GIC SOCOMO 100 is that its performance is not dependent upon on the survival of a multilayer coated reflective surface. Example embodiments of GIC mirror MG have at least one segmented GIC mirror shell, such as GIC mirror shell M1 shown in FIG. 6. GIC mirror shell M1 is shown as having a two mirror segments M1A and M1B with respective first and second surfaces Sf1 and Sf2. First surface Sf1 provides the first reflection (and is thus the “first mirror”) and second surface Sf2 provides a second reflection that is not in the line of sight to LPP 24. In an example embodiment, second surface Sf2 supports a multilayer coating 18 since the intensity of the once-reflected EUV radiation 30 is substantially diminished and is not normally in the line of sight of LPP 24, thus minimizing the amount of ions and neutral atoms incident upon the multilayer coating 18.

GIC vs. NIC SOCOMOs

There are certain trade-offs associated with using a LPP-GIC SOCOMO 100 versus a LPP-NIC SOCOMO 10. For example, for a given collection angle of the EUV radiation 30 from the LPP 24, the LPP-NIC SOCOMO 10 can be designed to be more compact than the LPP-GIC SOCOMO 100.

Also, the LPP-NIC SOCOMO 10 can in principle be designed to collect EUV radiation 30 emitted from the source at angles larger than 90° (with respect to the optical axis A1), thus allowing larger collection efficiency. However, in practice this advantage is not normally used because it leads to excessive NIC diameters or excessive angles that the EUV radiation 30 forms with the optical axis A1 at intermediate focus IF.

Also, the far field intensity distribution generated by a LPP-GIC SOCOMO 100 has additional obscurations due to the shadow of the thickness of the GIC mirror shells M1 and M2 and of the mechanical structure supporting the GIC mirrors MG. However, the present disclosure discusses embodiments below where the GIC surface includes a surface correction that mitigates the shadowing effect of the GIC mirror shells thicknesses and improves the uniformity of the focal spot FS at the intermediate focus IF.

Further, the focal spot FS at intermediate focus IF will in general be larger for a LPP-GIC SOCOMO 100 than for a LPP-NIC SOCOMO 10. This size difference is primarily associated with GIC mirror figure errors, which are likely to decrease as the technology evolves.

On the whole, it is generally believed that the above-mentioned trade-offs are far outweighed by the benefits of a longer operating lifetime, reduced cost, simplicity, and reduced maintenance costs and issues associated with a LPP-GIC SOCOMO 100.

### Example GIC Mirror for LPP-GIC SOCOMO

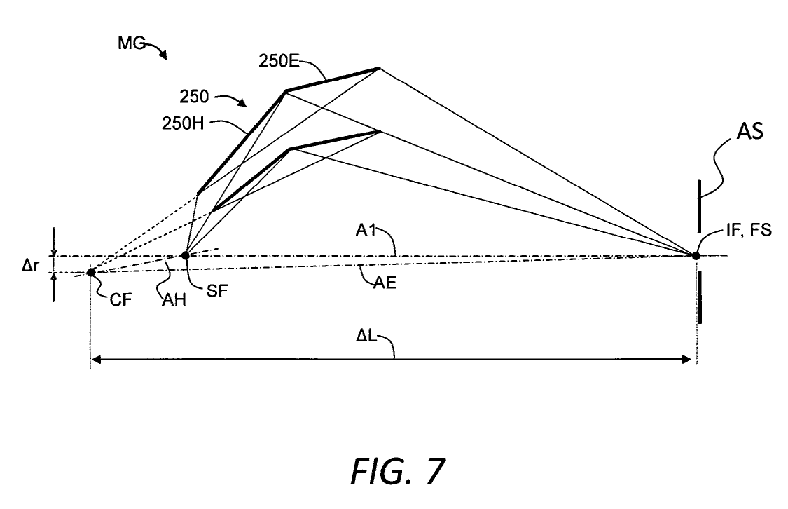

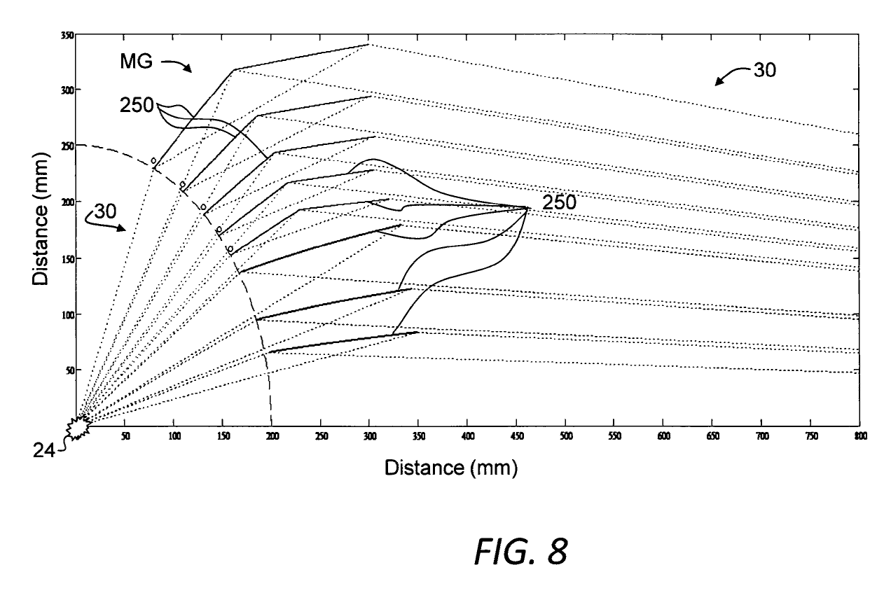

FIG. 7 is a schematic side view of a portion of an example GIC mirror MG for use in LPP-GIC SOCOMO 100. By way of example, the optical design of GIC mirror MG of FIG. 7 actually consists of eight nested GIC mirror shells 250 with cylindrical symmetry around the optical axis A1, as shown in FIG. 8. To minimize the number of GIC mirror shells 250, in the present example the first three innermost GIC mirror shells 250 are elliptical, whereas the five outermost GIC mirror shells 250 are based on an off-axis double-reflection design having elliptical and hyperbolic cross sections, such as described in European Patent Application Publication No. EP1901126A1, entitled “A collector optical system,” which application is incorporated by reference herein. FIG. 7 shows two of the outermost GIC mirror shells 250 having an elliptical section 250E and a hyperboloidal section 250H. FIG. 7 also shows the source focus SF, the virtual common focus CF, and the intermediate focus IF, as well as the axes AE and AH for the elliptical and hyperboloidal sections 250E and 250H of GIC mirror shells 250, respectively. The distance between virtual common focus CF and intermediate focus IF is ΔL. The virtual common focus CF is offset from the optical axis A1 by a distance Δr. The full optical surface is obtained by a revolution of the sections 250E and 250H around the optical axis A1.

Example designs for the example GIC mirror MG are provided in Table 1 and Table 2 below. The main optical parameters of the design are: a) a distance ΔL between LPP 24 and intermediate focus IF of 2400 mm; and b) a maximum collection angle at the LPP side of 70.7°. In an example embodiment, GIC mirror shells 250 each include a Ru coating for improved reflectivity at EUV wavelengths. The nominal collection efficiency of the GIC mirror MG for EUV radiation 30 of wavelength of 13.5 nm when the optical surfaces of GIC mirror shells 250 are coated with Ru is 37.6% with respect to 2π steradians emission from LPP 24.

Since an LPP EUV source is much smaller than a discharge-produced plasma (DPP) EUV source (typically by a factor of 10 in area), the use of LPP 24 allows for better etendue matching between the output of GIC mirror MG and the input of the illuminator. In particular, the collection angle at LPP 24 can be increased to very large values with negligible or very limited efficiency loss due to mismatch between the GIC mirror MG and illuminator etendue. In an example embodiment, the collection half-angle can approach or exceed 70°.

The dimension of LPP 24 has a drawback in that the uniformity of the intensity distribution in the far field tend to be worse than for a DPP source, for a given collector optical design. Indeed, since the LPP 24 is smaller, the far-field shadows due to the thicknesses of GIC mirror shells 250 tend to be sharper for an LPP source than for a DPP source.

To compensate at least partially for this effect, a surface figure (i.e., optical profile) correction is added to each GIC mirror shell 250 to improve the uniformity of the intensity distribution in the far field (see, e.g., Publication No. WO2009-095219 A1, entitled “Improved grazing incidence collector optical systems for EUV and X-ray applications,” which publication is incorporated by reference herein). Thus, in an example embodiment of GIC mirror MG, each GIC mirror shell 250 has superimposed thereon a polynomial (parabolic) correction equal to zero at the two edges of the GIC mirror shells 250 and having a maximum value of 0.01 mm.

Table 1 and Table 2 set forth an example design for the GIC mirror MG shown in FIG. 10. The “mirror #” is the number of the particular GIC mirror shell 250 as numbered starting from the innermost GIC mirror shell 250 to the outermost GIC mirror shell 250.

TABLE 1

| | Hyperbola | | Ellipse | | Mirror radii [mm] | | |
|---|---|---|---|---|---|---|---|
| | | Radius of | | Radius of | | Ellipse- | |
| | Conic | curvature | Conic | curvature | | hyperbola | |
| Mirror # | Constant | [mm] | Constant | [mm] | Maximum | joint | Minimum |
| 1 | — | — | −0.990478 | 11.481350 | 83.347856 | — | 65.369292 |
| 2 | — | — | −0.979648 | 24.674461 | 122.379422 | — | 94.644337 |
| 3 | — | — | −0.957302 | 52.367323 | 179.304368 | — | 137.387744 |
| 4 | −1.066792 | 29.401382 | −0.963621 | 61.100890 | 202.496127 | 192.634298 | 152.384167 |
| 5 | −1.072492 | 34.268782 | −0.949865 | 86.379783 | 228.263879 | 216.839614 | 169.639161 |
| 6 | −1.090556 | 46.865545 | −0.941216 | 104.704248 | 257.297034 | 243.541412 | 188.559378 |
| 7 | −1.111163 | 61.694607 | −0.926716 | 134.626393 | 293.432077 | 276.198514 | 208.671768 |
| 8 | −1.134540 | 81.393448 | −0.905453 | 180.891785 | 340.258110 | 317.294990 | 229.102808 |

TABLE 2

Position of virtual common focus CF
with respect to intermediate focus IF

| | ΔL, parallel to | Δr, transverse to |
|---|---|---|
| | optical axis A1 | optical axis A1 |
| Mirror # | [mm] | [mm] |
| 1 | — | — |
| 2 | — | — |
| 3 | — | — |
| 4 | 3293.000000 | 171.500000 |
| 5 | 3350.000000 | 237.000000 |
| 6 | 3445.000000 | 276.300000 |
| 7 | 3521.000000 | 335.250000 |
| 8 | 3616.000000 | 426.950000 |

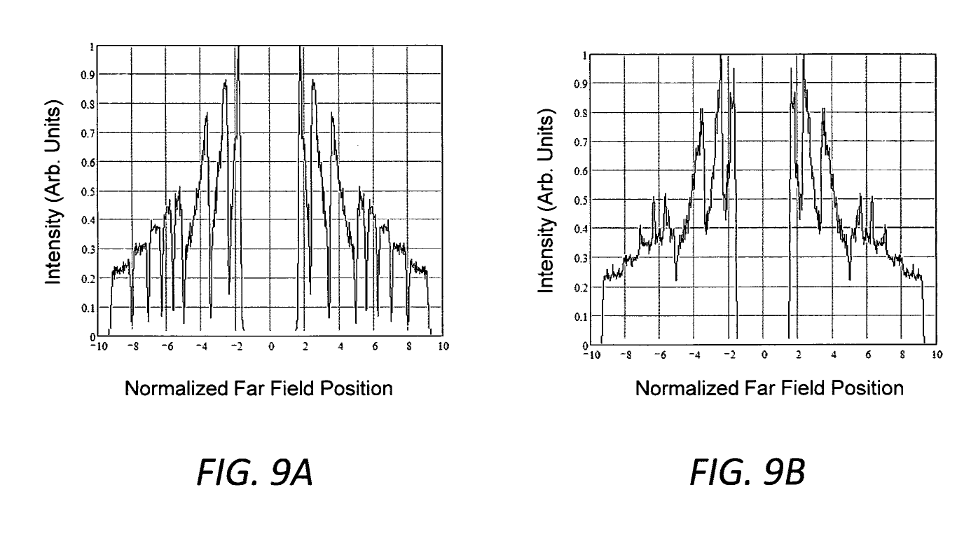

FIG. 9A is a plot of the normalized far-field position at the intermediate focus IF vs. intensity (arbitrary units) for light rays incident thereon for the case where there is no correction of the GIC mirror shell profile. The plot is a measure of the uniformity of the intermediate image (i.e., “focal spot” FS) of LPP 24 as formed at the intermediate focus IF. LPP 24 is modeled as a sphere with a 0.2 mm diameter.

FIG. 9B is the same plot except with the above-described correction added to GIC mirror shells 250. The comparison of the two plots of FIG. 9A and FIG. 9B shows substantially reduced oscillations in intensity in FIG. 9B and thus a significant improvement in the far field uniformity the focal spot FS at the intermediate focus IF as a result of the corrected surface figures for the GIC mirror shells 250.

EUV Lithography System with LPP-GIC SOCOMO

FIG. 10 is an example EUV lithography system (“lithography system”) 300 according to the present disclosure. Example lithography systems 300 are disclosed, for example, in U.S. Patent Applications No. US2004/0265712A1, US2005/0016679A1 and US2005/0155624A1, which are incorporated herein by reference.

Lithography system 300 includes a system axis A3 and an EUV light source LS that includes LPP-GIC SOCOMO 100 with optical axis A1 and having the Sn wire-based LPP target system 40 as described above, which generates LPP 24 that emits working EUV radiation 30 at λ=13.5 nm.

LPP-GIC SOCOMO 100 includes GIC mirror MG and optional RCED 110 as described above. In an example embodiment, GIC mirror MG is cooled as described in U.S. patent application Ser. No. 12/592,735, which is incorporated by reference herein. Also in an example, RCED 110 is cooled.

GIC mirror MG is arranged adjacent and downstream of EUV light source LS, with optical (collector) axis A1 lying along system axis A3. GIC mirror MG collects working EUV radiation 30 (i.e., light rays LR) from EUV light source LS located at source focus SF and the collected radiation forms source image IS (i.e., a focal spot) at intermediate focus IF. RCED 110 serves to enhance the collection of EUV radiation 30 by funneling to intermediate focus IF the EUV radiation 30 that would not otherwise make it to the intermediate focus IF. In an example, LPP-GIC SOCOMO 100 comprises LPP target system 40, GIC mirror MG and RCED 110.

An embodiment of RCED 110 as discussed above in connection with FIG. 3B includes at least one funnel element 111. In one example, funnel element 111 is a downstream funnel element 111D configured to direct EUV radiation 30 from focal spot FS at intermediate focus IF to a downstream location, such as the illumination optics (illuminator) downstream of the intermediate focus IF. In another example, funnel element 111 is an upstream funnel element 111U that directs EUV radiation 30 to form focal spot FS at intermediate focus IF, including collecting radiation that would not otherwise participate in forming the focal spot FS. In an example, RCED 110 includes both upstream and downstream funnel elements 111U and 111D. RCED 110 serves to make the projected radiation at the illuminator more uniform and thereby better utilized at the reticle plane.

An illumination system 316 with an input end 317 and an output end 318 is arranged along system axis A3 and adjacent and downstream of GIC mirror MG with the input end adjacent the GIC mirror MG. Illumination system 316 receives at input end 317 EUV radiation 30 from source image IS and outputs at output end 318 a substantially uniform EUV radiation beam 320 (i.e., condensed EUV radiation. Where lithography system 300 is a scanning type system, EUV radiation beam 320 is typically formed as a substantially uniform line (e.g. ring field) of EUV radiation 30 at reflective reticle 336 that scans over the reflective reticle 336.

A projection optical system 326 is arranged along (folded) system axis A3 downstream of illumination system 316 and downstream of the illuminated reflective reticle 336. Projection optical system 326 has an input end 327 facing output end 318 of illumination system 316, and an opposite output end 328. A reflective reticle 336 is arranged adjacent input end 327 of projection optical system 326 and a semiconductor wafer 340 is arranged adjacent the output end 328 of projection optical system 326. Reflective reticle 336 includes a pattern (not shown) to be transferred to semiconductor wafer 340, which includes a photosensitive coating (e.g., photoresist layer) 342. In operation, the uniformized EUV radiation beam 320 irradiates reflective reticle 336 and reflects therefrom, and the pattern thereon is imaged onto photosensitive coating 342 of semiconductor wafer 340 by projection optical system 326. In a scanning type lithography system 300, the reflective reticle image scans over the photosensitive coating 342 to form the pattern over the exposure field. Scanning is typically achieved by moving reflective reticle 336 and semiconductor wafer 340 in synchrony.

Once the reticle pattern is imaged and recorded on semiconductor wafer 340, the patterned semiconductor wafer 340 is then processed using standard photolithographic and semiconductor processing techniques to form integrated circuit (IC) chips.

Note that in general the components of lithography system 300 are shown lying along a common folded system axis A3 in FIG. 10 for the sake of illustration. One skilled in the art will understand that there is often an offset between entrance and exit axes for the various components such as for illumination system 316 and for projection optical system 326.

It will be apparent to those skilled in the art that various modifications and variations can be made to the present disclosure without departing from the spirit and scope of the disclosure. Thus it is intended that the present disclosure cover the modifications and variations of this disclosure provided they come within the scope of the appended claims and their equivalents.

1. A source-collector module for an extreme ultraviolet (EUV) lithography system, comprising:
a laser that generates a pulsed laser beam;
a fold mirror arranged along a source-collector module axis and configured to receive the pulsed laser beam and reflect the pulsed laser beam down the source-collector module axis in a first direction;
a Sn wire source configured to move a Sn wire over a wire guide path that includes an irradiation location where the Sn wire is irradiated by the pulsed laser beam, thereby creating a laser-produced plasma (LPP) that generates EUV radiation in a second direction that is generally opposite the first direction; and
a grazing-incidence collector (GIC) mirror having an input end and an output end and arranged to receive the EUV radiation at the input end and focus the received EUV radiation at an intermediate focus adjacent the output end.

2. The source-collector module of claim 1, further comprising:
a supply reel that stores a length of Sn wire to be irradiated by the laser beam;
a take-up reel that receives Sn wire that has been irradiated by the laser beam; and
at least one guide wire unit configured to guide the Sn wire over the wire guide path.

3. The source-collector module of claim 2, wherein the at least one guide wire unit includes at least one roller.

4. The source collector module of claim 3, wherein one of the at least one rollers is a drive roller.

5. The source-collector module of claim 1, wherein the Sn wire is selected from the group of Sn wires comprising: tape, chain, foil tape, beaded chain, ribbon, rope, cable, thread, conventional wire and line.

6. The source-collector module of claim 1, wherein the Sn wire comprises a non-Sn structure with a Sn coating having a thickness of about 0.5 micron or greater.

7. The source-collector module claim 1, further comprising a radiation collection enhancement device (RCED) arranged adjacent the intermediate focus, the RCED having at least one funnel element axially arranged on at least one side of the intermediate focus, with the at least one funnel element having a narrow end closest to the intermediate focus.

8. The source-collector module of claim 7, wherein the RCED includes first and second funnel elements arranged on respective sides of the intermediate focus.

9. The source-collector module of claim 1, wherein the GIC mirror provides a first reflecting surface that does not have a multilayer coating.

10. The source-collector module of claim 1, wherein the GIC mirror includes one of a Ru coating and a multilayer coating.

11. The source-collector module claim 1, wherein the GIC mirror includes at least one segmented GIC shell having a first reflecting surface with no multilayer coating and a second reflecting surface having a multilayer coating.

12. An extreme ultraviolet (EUV) lithography system for illuminating a reflective reticle, comprising:
the source-collector module of claim 1; and
an illuminator configured to receive the focused EUV radiation formed at the intermediate focus and form condensed EUV radiation for illuminating the reflective reticle.

13. The EUV lithography system of claim 12, further comprising a radiation collection enhancement device (RCED) arranged adjacent the intermediate focus, the RCED having at least one funnel element axially arranged on at least one side of the intermediate focus, with the at least one funnel element having a narrow end closest to the intermediate focus, wherein the RCED serves to provide more EUV radiation to the illuminator than when the RCED is absent.

14. The EUV lithography system of claim 13 for forming a patterned image on a photosensitive semiconductor wafer, further comprising:
a projection optical system arranged downstream of the reflective reticle and configured to receive reflected EUV radiation from the reflective reticle and form therefrom the patterned image on the photosensitive semiconductor wafer.

15. A method of collecting extreme ultraviolet (EUV) radiation from a laser-produced plasma (LPP), comprising:
providing a grazing incidence collector (GIC) mirror along an axis, the GIC mirror having input and output ends;
arranging adjacent the input end of GIC mirror an LPP target system configured to provide Sn wire having a diameter, including moving the Sn wire past an irradiation location;
sending a pulsed laser beam down the axis of GIC mirror and through the GIC mirror from the output end to the input end and focused onto the Sn wire at the irradiation location with a focal spot size being smaller than the Sn wire diameter, thereby forming the LPP that emits the EUV radiation; and
collecting with the GIC mirror at the input end of GIC mirror a portion of the EUV radiation from the LPP and directing the collected EUV radiation out of the output end of GIC mirror to form a focal spot at an intermediate focus.

16. The method of claim 15, further comprising:
providing a radiation collection enhancement device (RCED) arranged adjacent the intermediate focus, the RCED having at least one funnel element axially arranged on at least one side of the intermediate focus, with the at least one funnel element having a narrow end closest to the intermediate focus.

17. The method of claim 15, further comprising:
providing an upstream funnel element between the output end of GIC mirror and the intermediate focus and directing with the upstream funnel element a portion of the EUV radiation to the intermediate focus that would not otherwise be directed to the intermediate focus; and
providing a downstream funnel element adjacent the intermediate focus opposite the GIC mirror so as to collect EUV radiation from the intermediate focus and direct it to a downstream location.

18. The method of claim 15, further comprising moving the Sn wire over a wire guide path defined by a storage reel, a take-up reel and at least one guide wire unit.

19. The method of claim 15, further comprising:
providing the GIC mirror with a first reflecting surface that does not have a multilayer coating.

20. The method of claim 15, further comprising:
providing the GIC mirror with one of a Ru coating and a multilayer coating.

21. The method of claim 15, further comprising:
providing the GIC mirror with at least one segmented GIC shell that includes a first reflecting surface and a second reflecting surface, with the second reflecting surface having the multilayer coating.

22. The method of claim 15, further comprising:
forming, from EUV radiation at the intermediate focus, condensed EUV radiation for illuminating a reflective reticle.

23. The method of claim 22, further comprising:
receiving reflected EUV radiation from the reflective reticle to form therefrom the patterned image on the photosensitive semiconductor wafer using a projection optical system.

24. A laser produced plasma (LPP) target system, comprising:
a laser that generates a pulsed laser beam;
a Sn wire storage reel that stores a length of Sn wire;
a Sn wire take-up reel that stores a length of irradiated Sn wire; and
at least one guide wire unit that guides the Sn wire over a wire guide path from the storage reel to the take-up reel, with the wire guide path including an irradiation location between the storage-reel and the take-up reel where the Sn wire is irradiated by the pulsed laser beam.
